(19) United States
(12) Patent Application Publication
(10) Pub. No.: US 2008/0050481 A1
(43) Pub. Date: Feb. 28, 2008

(54) Controlled Atmosphere

(76) Inventor: Stephen Morris, North Ryde (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/814,269

(22) PCT Filed: Jan. 18, 2006
(86) PCT No.: PCT/AU06/00060

§ 371 Date: Sep. 14, 2007

(30) Foreign Application Priority Data
Jan. 18, 2005 (AU) 2005900216

(51) Int. Cl. A23B 7/148; A23L 3/3418

(52) U.S. Cl. 426/232; 99/468

(57) ABSTRACT

A method, system and apparatus for maintaining a controlled atmosphere having a high carbon dioxide content in a sealed container is provided. In the method, the container is substantially impermeable to oxygen and carbon dioxide and contains respiring horticultural produce. The method comprises monitoring the oxygen or carbon dioxide content in the atmosphere and, when the oxygen content approaches a level at which the produce becomes anaerobic, delivering a gas containing oxygen into the container such that the oxygen content in the atmosphere is again sufficient to allow the produce to respire. The high carbon dioxide content in the atmosphere causes the storage life of the produce to be extended.

### TECHNICAL FIELD

The present invention relates to a method, system and apparatus for maintaining a controlled atmosphere having a high carbon dioxide content around horticultural produce.

### BACKGROUND ART

Once horticultural produce such as fruit, vegetables, flowers, nuts, or mushrooms is harvested, it actively respires by continually consuming oxygen and producing carbon dioxide.

By reducing the oxygen content in the atmosphere surrounding such horticultural produce, it is possible to slow down the process of aging and thereby extend the storage life of the produce. The storage life of produce such as apples and pears, for example, may be extended by using a controlled atmosphere (CA) storage system, in which nitrogen is introduced into the storage atmosphere so that the oxygen content is reduced (typically to 0.5-3% of the total atmosphere). The reduced oxygen content is low enough to extend storage life but high enough to keep the produce healthy. Such systems may be used to extend the storage life of some produce by up to ten months.

Such systems, however, are typically used in large scale processes where hundreds of tonnes of produce is stored. Large volumes of produce need to be stored because conventional CA systems require elaborate and precise atmosphere and temperature control systems that are very expensive to install and run. Levels of oxygen, nitrogen and carbon dioxide in the CA are monitored and additional quantities of each gas are added when necessary, typically from a gas canister or a gas generator.

For certain types of horticultural produce, an atmosphere having a high carbon dioxide content has been found to be very beneficial for extending storage life, principally by reducing decay but also by slowing down softening and ripening.

It would be advantageous to provide a method, system and apparatus for maintaining a controlled atmosphere having a high carbon dioxide content.

### DISCLOSURE OF THE INVENTION

The present invention provides a method for maintaining a controlled atmosphere having a high carbon dioxide content in a sealed container, the container being substantially impermeable to oxygen and carbon dioxide and containing respiring horticultural produce, the method comprising monitoring the oxygen or carbon dioxide content in the atmosphere and when the oxygen content approaches a level at which the produce becomes anaerobic, a gas containing oxygen is delivered into the container such that the oxygen content in the atmosphere is again sufficient to allow the produce to respire, whereby the high carbon dioxide content in the atmosphere causes the storage life of the produce to be extended.

In the method, an atmosphere having high carbon dioxide content typically contains between about 14-30% carbon dioxide.

As the person skilled in the art would understand, produce becomes anaerobic when the atmosphere does not contain sufficient oxygen to enable the produce to respire. The consequence of this anaerobic condition is that the produce ceases to use oxygen during respiration, resulting in the production of alcohols (because the respiration process does not proceed to completion whereby carbon dioxide and water are formed) and the produce acquiring alcoholic flavours and odours.

The point at which produce becomes anaerobic is dependent on the type of produce and the temperature. For example, when oxygen levels drop below 1-2% at room temperature, strawberries become anaerobic and start to develop alcoholic taints. As there may be some variation of the oxygen content throughout the container, it is desirable to have a safety margin of about 1-2% above the anaerobic point of the produce in order to ensure that none of the produce in the container becomes anaerobic. Accordingly, when the oxygen content in the container approaches a level at which the produce becomes anaerobic (i.e. the oxygen content is about 1-2% above the anaerobic point of the produce), in order for all of the produce to continue to respire and not develop alcoholic taints, it is desirable to introduce more oxygen into the container.

The gas containing oxygen is delivered into the container until the oxygen content in the atmosphere is again sufficient to allow the produce to respire. This level of oxygen is dependent on the type of produce being stored, however, the oxygen content is typically increased to about 2-3% above the product's anaerobic point.

Whilst the container is substantially impermeable to oxygen and carbon dioxide, a very slight degree of permeability can result in a higher carbon dioxide content in the atmosphere within the container. A higher carbon dioxide content may be beneficial in further extending the storage life of the produce by, for example, further inhibiting the growth of mould. Furthermore, containers that are completely impermeable to oxygen and carbon dioxide are very expensive and unlikely to be commercially viable. However, if the container is too permeable to oxygen or carbon dioxide, it is extremely difficult to maintain a controlled environment having a high carbon dioxide content inside the container in order to extend the storage life of the produce.

The method of the present invention can advantageously provide a controlled atmosphere having a high carbon dioxide content, without the need for complex equipment and/or careful control of parameters such as the temperature and weight of the produce stored in the container. The high carbon dioxide content enables the storage life of the produce to be extended, especially given the combination of high carbon dioxide content and low oxygen content. Furthermore, it is the respiring fruit that provides the high levels of carbon dioxide in the atmosphere and bottled carbon dioxide is therefore not required.

Apparatus for performing the method of the present invention can also advantageously be used in existing storage facilities, for example in cool rooms.

In some embodiments, when the gas containing oxygen is delivered into the container, excess atmosphere is expelled from the container. This would occur in embodiments in which the container has a fixed volume, for example, when the container is a pallet bin.

The carbon dioxide content in the atmosphere is typically maintained between about 14 and about 24%, and preferably between about 15 and about 18%. In some embodiments, the carbon dioxide content in the atmosphere is maintained between about 14 and about 20%.

The oxygen content in the atmosphere is typically maintained between about 3 and about 6%, and preferably between about 4 and about 5%. In some embodiments, the oxygen content in the atmosphere is maintained between about 2 and about 3% or between about 3 and about 5%.

The levels between which the carbon dioxide and oxygen are maintained in the atmosphere depend on the type of horticultural produce to be stored.

Typically, it is the oxygen content in the atmosphere that is monitored, for example using an oxygen sensor. Whilst it is possible to maintain a controlled atmosphere having a high carbon dioxide content using a carbon dioxide sensor (as discussed below), these are more expensive and require more power than oxygen sensors. Carbon dioxide sensors are therefore less suitable for use in systems drawing power from batteries or low power DC sources.

Typically, the method of the present invention is carried out at a temperature of between about −2 and about 2° C. in order to further extend the storage life of the produce. For example, the method may be carried out within a standard cool room.

Alternatively, the delivery of the gas containing oxygen into the container may be increased in order to compensate for higher temperatures (at higher temperatures, produce consumes more oxygen as it respires). The person skilled in the art would choose an appropriate temperature to carry out the method of the present invention, depending on the type of produce to be stored. However, unlike CA storage systems which require precise temperature control, the method of the present invention automatically compensates for the changing oxygen requirements of the produce with changes in temperature, thereby maintaining optimal storage conditions.

Typically, the gas containing oxygen that is delivered into the container is air. Thus, in some embodiments, the respiring horticultural produce progressively converts oxygen in the container to carbon dioxide until the oxygen content in the atmosphere drops below a set point above the anaerobic point of the produce stored in the container. At this time, air is pumped into the container, for example, at the opposite side of the container to the oxygen or carbon dioxide sensor. The excess atmosphere may be expelled via a tube leading to a one way valve, the entrance to which may, for example, be situated close to the sensor. Excess atmosphere is expelled until a desirable level of oxygen is again achieved inside the container.

The method of the present invention can be used to extend the storage life of any respiring horticultural produce that can tolerate a high carbon dioxide atmosphere. Horticultural produce which has an extended storage life under a high carbon dioxide atmosphere include strawberries and other soft berries such as raspberries, blackberries and blueberries etc, a range of nuts such as chestnuts, and also soft fruits such as peaches, nectarines, plums, persimmons, figs and table grapes.

The present invention also provides a system for maintaining a controlled atmosphere having a high carbon dioxide content around horticultural produce, the system comprising:
a sealable container adapted to receive and store respiring horticultural produce, the container being substantially impermeable to oxygen and carbon dioxide;
a monitor for monitoring the oxygen or carbon dioxide content of the atmosphere in the container; and
a delivery device for delivering a gas containing oxygen into the container when the oxygen content approaches a level at which the produce would become anaerobic;
   whereby the high carbon dioxide content in the atmosphere in the container is maintainable such that the storage life of the produce may be extended.

The system of the present invention can be used to perform the method of the present invention.

Typically, the system further comprises a valve through which excess atmosphere from the container is expelled when the gas containing oxygen is delivered into the container. In such embodiments, the valve is typically in fluid communication with a tube, an entrance to the tube being situated close to the monitor, and the delivery device delivers the gas containing oxygen into a remote side (for example an opposite side) of the container to the monitor. In these embodiments, maximum mixing of the atmosphere in the container occurs and there is less likely to be any problems associated with “short circuiting” of the atmosphere around the sensor.

In some embodiments of the system of the present invention, the oxygen content of the atmosphere in the container is monitored by an oxygen sensor. The oxygen sensor may, for example, be linked to a controller such that, when the oxygen content approaches the level at which the produce becomes anaerobic, the controller causes the delivery device to deliver air into the container.

In some embodiments, the controller is operable to adjust the volume of the air delivered into the container. Thus, in such embodiments, the delivery of the air into the container may be increased, for example, if the system is not stored in a cool room and the produce requires more oxygen to respire.

Typically, the sealable container is defined by a pallet bin that is surrounded by a substantially impermeable plastic bag.

The present invention also provides an apparatus comprising:
a sealable container adapted to receive and store respiring horticultural produce, the container being substantially impermeable to oxygen and carbon dioxide;
a monitor for monitoring the oxygen or carbon dioxide content of the atmosphere in the container;
a delivery device for delivering a gas containing oxygen into an opposite side of the container to the monitor when the oxygen content approaches a level at which the produce would become anaerobic; and
a valve through which excess atmosphere from the container is expelled when the gas containing oxygen is delivered into the container;
   whereby a high carbon dioxide content in the atmosphere in the container is maintainable such that the storage life of the produce may be extended.

Preferably, the valve is in fluid communication with a tube, an entrance to the tube being situated close to the monitor.

### BRIEF DESCRIPTION OF THE DRAWINGS

A preferred embodiment of the present invention will now be described by way of example only, with reference to the following drawings in which:

FIG. 1 schematically depicts an apparatus that may be used to perform the method or system of the present invention; and

FIG. 2 shows a more detailed view of the controller used in the apparatus of FIG. 1.

Non-limiting examples showing extension of the storage life of chestnuts will also be described, with reference to the following figures in which:

FIG. 3 shows a graph of the oxygen content of the atmosphere of a sealed container containing chestnuts versus time;

FIG. 4 shows the percentage of external rot on chestnuts stored in containers in accordance with embodiments of the present invention, as well as chestnuts stored in a control container;

FIG. 5 shows the percentage of internal rot in the chestnuts stored in the containers referred to in FIG. 4; and

FIG. 6 shows the percentage of external rot of chestnuts stored under various conditions, including conditions in accordance with embodiments of the present invention.

### DESCRIPTION OF PREFERRED EMBODIMENTS OF THE INVENTION

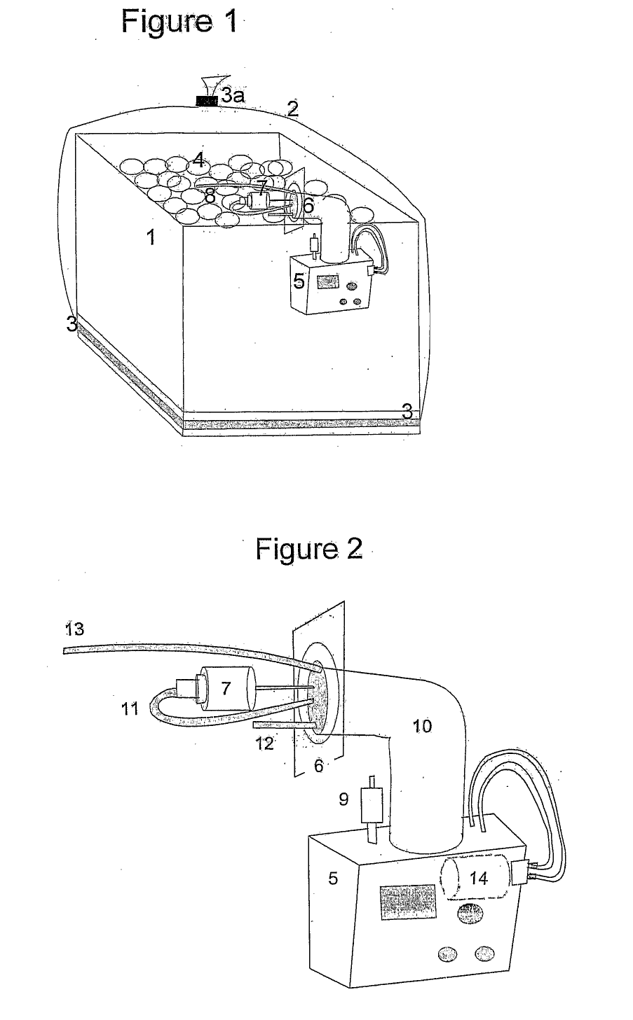

Referring to FIGS. 1 and 2, an embodiment of the apparatus of the present invention is depicted. This apparatus can be used to perform the method or the system of the present invention. A pallet bin or similar container (1) formed from, for example, dressed timber or marine ply is surrounded by a thick plastic bag (2) or a similar flexible barrier that is substantially impermeable to oxygen and carbon dioxide. The bag (2) is sealed to an impermeable base (3) of the container (1) with a high quality adhesive tape, and tied in a completely air tight fashion at the top (3a) with cable ties or similar. The bin (1) and bag (2) encase the respiring horticultural produce (4) and define an internal atmosphere in which the produce (4) may be stored in a high carbon dioxide atmosphere (as will be described below).

In alternate embodiments (not shown), the bag may be situated inside the bin, however, in such cases there is less storage space for the produce and the system is more difficult to set up. Alternatively, the bin itself may be sealable and no bag is required.

If the system is to be stored in a cool room, it is desirable to cool the produce (4) to the cool room temperature prior to sealing in order to minimise condensation inside the bag (2).

The oxygen and carbon dioxide content (the oxygen content and carbon dioxide content of an atmosphere at standard atmospheric pressure added together usually amount to about 19-23% of the total atmosphere) inside the bag (2) is controlled by a controller (5). The controller (5) is connected to the bag (2) via an interface sealing plate (6) using a pressure fit seal. An oxygen sensor (7) and its associated cable pass through the interface plate (6) and are located inside the bag (2) such that the sensor (7) detects the oxygen content in the atmosphere inside the bag (2). The oxygen sensor (7) may be of any known type, but for operation in high humidity atmospheres and at temperatures around 0° C., a suitable temperature compensated electrochemical galvanic oxygen sensor works well and lasts for several years before needing replacement.

Suitable oxygen sensors include a MSA MiniOx O₂ Sensor Model 406931 (MSA Inc., Pittsburgh, Pa., USA). Alternate oxygen sensors that can be used include a Maxtec MAX-13 Oxygen Sensor (Maxtec Inc., Salt Lake City, Utah, USA) or an Analytical Industries PSR-11-39-JD Oxygen Sensor (Analytical Industries Inc., Pomona, Calif., USA).

As described above, carbon dioxide sensors may also be used to monitor the carbon dioxide content of the atmosphere surrounding the produce. If the carbon dioxide content in an atmosphere is known, it is possible to estimate the oxygen content of the atmosphere because the sum of the carbon dioxide and oxygen contents in the atmosphere usually amounts to approximately 21% (at RTP). However, as also discussed above, carbon dioxide sensors require high power to run and are expensive. Further, it is only possible to obtain estimates of the oxygen content in the atmosphere using a carbon dioxide sensor, and therefore there is some risk that the produce may unintentionally become anaerobic. Nevertheless, the present inventors have investigated the following carbon dioxide sensors: Vaisala CARBOCAPO Carbon Dioxide Module Series GMM220 (Digital Control Systems Inc.), AirSense™ Model 400 (Edinburgh Instruments) and Gascard II (0-30%).

Three tubes (8) also pass through the interface plate (6) and into the atmosphere inside the bag (2). As can be seen more clearly in FIG. 2, the first tube (13) carries fresh air to the opposite side of the bin (1) to the oxygen sensor (7). The second tube (12) is for exhaust air and is connected to a one way valve, and the third tube (11) carries fresh air directly to the oxygen sensor for calibration purposes. Each of these components will be described in further detail below.

The controller (5) ideally displays the oxygen content within the internal atmosphere; can calibrate the system (as described below) because the sensor output may drift slightly over time; and can be used to adjust the sensor output in order to maintain the correct content of oxygen inside the bag. The controller (5) also ideally has indicators to show when the air pump is operating, and can set off an alarm if necessary if the oxygen content in the internal atmosphere becomes too low. Further, the controller (5) would ideally also have indicators to show the actual air flow into the internal atmosphere in addition to the indicators that show when the pump is operating.

The system typically runs off DC power or batteries, depending on the quantity of produce being stored and the length of the storage time involved.

Referring specifically to FIG. 2, the controller (5) and its various components are more clearly shown. Attached to the controller is a one way valve (9), which allows the excess atmosphere to be expelled from the container when fresh air is added. The controller (5) is attached to the interface sealing plate (6) via a connecting tube (10), with the inner part of the tube being contiguous with the internal atmosphere and connected to the plate (6) by an air tight seal such as a pressure fit seal.

Within the container is the oxygen sensor (7). The tube (11) delivers fresh air directly to the oxygen sensor (7) for calibration as, over time, the sensitivity of the oxygen sensor can vary slightly. Accordingly, every one or two months, the controller (5) may be set to calibrate the oxygen sensor (7) by pumping fresh air through tube (11) and directly to the sensor (7) and, after allowing about 1-2 minutes for the sensor to stabilise, the oxygen signal is reset to 2.1% oxygen, which is the usual level of oxygen in fresh air. Once this procedure is completed, the controller (5) continues its normal running procedure. This system allows the oxygen sensor (7) to be calibrated without breaking the high carbon dioxide atmosphere.

The entrance to the exhaust air tube (12) is situated close to the oxygen sensor (7) and connected to the one way valve (9). The fresh air inlet tube (13) extends to the far corner of the container (1) so that the maximum mixing of the internal atmosphere occurs without any short circuiting. The pump (14) that supplies the fresh air when required is illustrated within the controller.

Alternately, for ease of replacement if necessary, the pump can be located outside the controller and attached to it, rather than within the controller. The pump may be of any known type, but for operation under typical conditions within the cold storage rooms and with low voltage DC power, the best pumps are battery powered air pumps. Such pumps may need to be modified in order to interface with the power and control functions of the controller. Suitable pumps for use with the present invention include the Sonic DC 301 battery air pump and the Sonic DC303 battery air pump (Zhenhua Electrics, China), or the Shiruba K-102 12V air pump.

Since the pump is the only moving part of the system, they need to be regularly checked and replaced every two years or so depending on use.

It will be appreciated that the apparatus described above advantageously provides a relatively simple means for maintaining a controlled atmosphere having a high carbon dioxide content, as well as a low oxygen content, whereby the storage life of horticultural produce that can tolerate a high carbon dioxide atmosphere can be extended. The above apparatus is safe to use within cool rooms that may have damp floors because it can be run using low voltage DC power. Additionally, it may be used on a small scale in a reliable and economical manner, and can be used for both long term storage (for example, storing chestnuts) and short term storage (for example, storing strawberries). Furthermore, the carbon dioxide used to extend the storage life of the produce is produced in situ by the produce itself and there is therefore no need for bottled gasses.

The apparatus may also be provided as an integrated unit into which the produce is loaded for storage.

### EXAMPLES

To better illustrate the present invention, embodiments in which the storage life of horticultural produce in the form of chestnuts is extended will now be described. These embodiments are included by way of example only to illustrate the invention, and are not to be construed as limiting the scope of the invention in any way.

Four containers in the form of fruit bins 1 to 4 were sealed in a manner similar to that described above and the oxygen content in the atmosphere surrounding the chestnuts was monitored using a MSA MiniOx O₂ Sensor Model 406931 (MSA Inc., Pittsburgh, Pa., USA). The bins were stored in a cold room at a temperature of about −1° C. for 6 months.

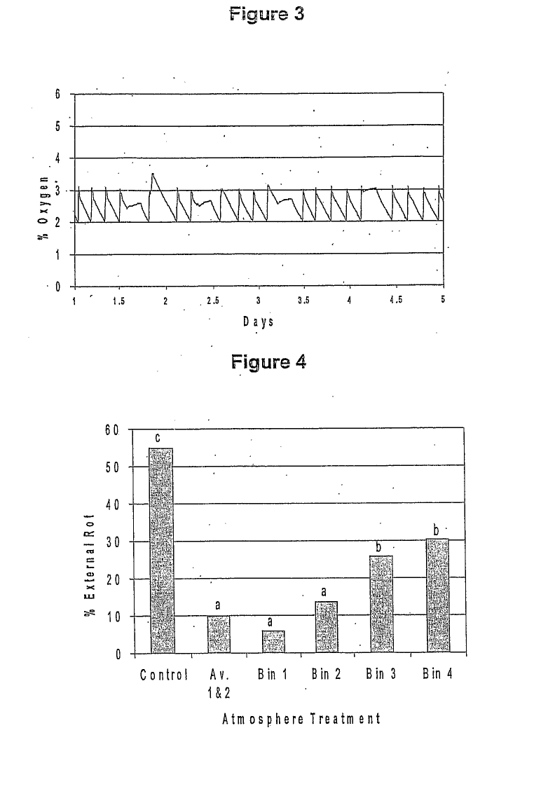

The oxygen content in the atmosphere inside bins 1 and 2 was maintained between about 2 and 3%, with a relatively slow cycle between these levels (see FIG. 3). The cycle consisted of a rapid increase to the upper oxygen level using a high air flow rate pump, followed by a slow decline to the lower oxygen level. In these bins, the control module was sealed to the bin in a substantially airtight manner, and the slow decline to the lower oxygen level was primarily caused by the respiring chestnuts.

The oxygen content in the atmosphere inside bins 3 and 4 was also maintained between about 2 and 3%, however, there was a relatively fast cycle between the high and low levels. The cycle consisted of a slower increase to the upper oxygen level using a relatively lower air flow rate pump, followed by a more rapid decline to the lower oxygen level. The more rapid decline to the lower oxygen level in these bins was due to poorer sealing methods of the control module to the bin, thus the oxygen in the atmosphere of bins 3 and 4 was depleted by both the respiring chestnuts, as well as by leakage.

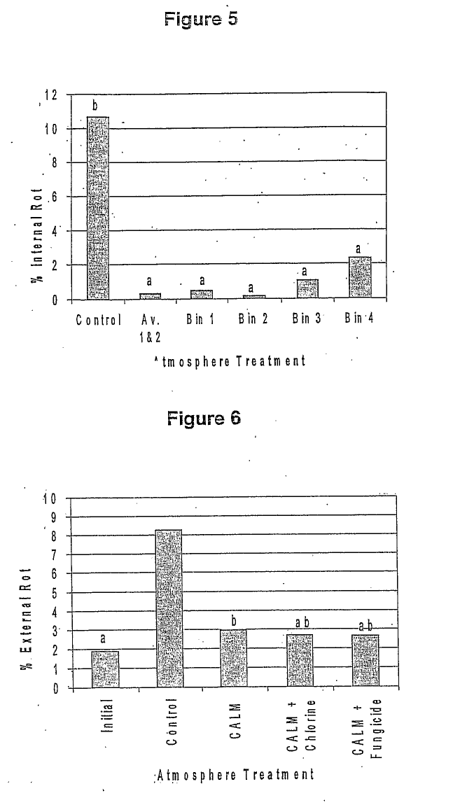

The reduction in decay and mould of the chestnuts stored in bins 1 to 4 are illustrated in FIGS. 4 and 5. These results are compared with a control in which chestnuts were stored at the same temperature for 6 months inside plastic lined hessian sacks, which are typically used in the industry to store chestnuts.

A sample of chestnuts from the control and each of bins 1 to 4 was assayed to determine the percentage of external and internal rot of the chestnuts. The results of these assays are shown in FIGS. 4 and 5. The letters appearing above the columns in FIGS. 4 and 5 indicate whether the differences between the results are statistically significant, i.e. if two columns have the same letter, then even though the columns appear to show a different % of external/internal rot, that difference is not statistically significant.

FIG. 4 shows the proportion of the vulnerable hilum area at the base of each chestnut examined which was covered with external mould or rot. External mould of more than about 15% causes unsightly chestnuts with unattractive black staining. These chestnuts are of reduced commercial value.

As can clearly be seen from the results shown in FIG. 4, the percentage of external rot of chestnuts stored in accordance with the present invention was dramatically reduced when compared with the control chestnuts. This is especially the case for bins 1 and 2, which had higher air flow rates than bins 3 and 4.

FIG. 5 shows the proportion of each chestnut examined that had internal rot, which was estimated after cutting each nut though the centre from top to bottom. As can be seen, bins 1 to 4 all had a similar amount of internal rot, which was much lower than the rot in the control chestnuts stored under normal commercial conditions.

Thus, excellent control of internal mould or rot in chestnuts also results when storing chestnuts in accordance with the present invention. Whilst similar or slightly improved control of external mould may be possible using a range of sanitisers or fungicides, such nuts could not be considered to be “organic” (which nuts stored in accordance with the present invention may be). However, the level of control of internal mould shown by the present invention is far superior to any level of control possible using any chemicals currently available.

The results of another experiment are shown in FIG. 6, which shows the percentage of chestnuts that had external rot after storage in various atmospheres for 4 months at a temperature of about −1° C. The percentage of external rot on the chestnuts was determined using the method discussed above.

Before the experiment was commenced, the chestnuts had 1.9% external rot (as can be seen from the column labelled “Initial”). Following storage, the chestnuts stored in accordance with the present invention, which are shown in the CALM (“Chestnut Atmosphere Longlife Module”) columns, had significantly less external rot than the control chestnuts, which were again stored inside plastic lined hessian sacks.

Chestnuts stored in accordance with the present invention, but which had been dipped prior to storage in either a sanitising chlorine solution (200 ppm of a sodium hypochlorite solution, shown in the column labelled “CALM+Chlorine”) or a commercial postharvest apple fungicide, for example Carbendazim (BASF Bavistin FL Systemic Fungicide, shown in the column labelled “CALM+Fungicide”) at 250 ppm were also evaluated. As can be seen, the level of external rot of such chestnuts was not significantly improved by dipping the chestnut in a sanitiser or fungicide prior to storage in accordance with the present invention. As noted previously, however, chestnuts treated in this manner cannot be considered to be “organic” chestnuts.

Although the present invention has been described with reference to particular embodiments, it will be appreciated by those skilled in the art that the invention may be embodied in many other forms. For example, in some embodiments of the present invention, the container may be expandable and expand when the gas containing oxygen is delivered into the container, thereby not requiring any of the internal atmosphere to be expelled from the container.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for maintaining a controlled atmosphere having a high carbon dioxide content in a sealed container, the container being substantially impermeable to oxygen and carbon dioxide and containing respiring horticultural produce, the method comprising monitoring the oxygen or carbon dioxide content in the atmosphere and when the oxygen content approaches a level at which the produce becomes anaerobic, a gas containing oxygen is delivered into the container such that the oxygen content in the atmosphere is again sufficient to allow the produce to respire, whereby the high carbon dioxide content in the atmosphere causes the storage life of the produce to be extended.

2. The method as claimed in claim 1 wherein, when the gas containing oxygen is delivered into the container, excess atmosphere is expelled from the container.

3. The method as claimed in claim 1, wherein the carbon dioxide content in the atmosphere is maintained between about 14 and about 24%.

4. The method as claimed in claim 1, wherein the carbon dioxide content in the atmosphere is maintained between about 15 and about 18%.

5. The method as claimed in claim 1, wherein the oxygen content in the atmosphere is maintained between about 3 and about 6%.

6. The method as claimed in claim 1, wherein the oxygen content in the atmosphere is monitored.

7. The method of claim 6, wherein the oxygen content of the atmosphere is monitored by an oxygen sensor.

8. The method of claim 1, wherein the method is carried out at a temperature of between about −2 and about 2° C.

9. The method of claim 1, wherein the gas containing oxygen is air.

10. The method of claim 1, wherein the respiring horticultural produce is selected from the group consisting of strawberries, raspberries, blueberries, blackberries, chestnuts, peaches, nectarines, plums, persimmons, figs and table grapes.

11. A system for maintaining a controlled atmosphere having a high carbon dioxide content around horticultural produce, the system comprising:
a sealable container adapted to receive and store respiring horticultural produce, the container being substantially impermeable to oxygen and carbon dioxide;
a monitor for monitoring the oxygen or carbon dioxide content of the atmosphere in the container; and
a delivery device for delivering a gas containing oxygen into the container when the oxygen content approaches a level at which the produce would become anaerobic;
whereby the high carbon dioxide content in the atmosphere in the container is maintainable such that the storage life of the produce may be extended.

12. The system as claimed in claim 11, which further comprises a valve through which excess atmosphere from the container is expelled when the gas containing oxygen is delivered into the container.

13. The system as claimed in claim 12, wherein the valve is in fluid communication with a tube, an entrance to the tube being situated close to the monitor, and the delivery device delivers the gas containing oxygen into a remote side of the container to the monitor.

14. The system as claimed in claim 11, wherein the oxygen content of the atmosphere in the container is monitored by an oxygen sensor.

15. The system as claimed in claim 14, wherein the oxygen sensor is linked to a controller such that, when the oxygen content approaches the level at which the produce becomes anaerobic, the controller causes the delivery device to deliver air into the container.

16. The system as claimed in claim 15, wherein the controller further comprises a calibrator for calibrating the oxygen sensor.

17. The system as claimed in claim 15 or 16, wherein the controller is operable to adjust the volume of air delivered into the container.

18. The system as claimed in claim 15, wherein the controller is battery powered.

19. The system as claimed in claim 11, wherein the container is defined by a pallet bin that is surrounded by a substantially impermeable plastic bag.

20. An apparatus comprising:
a sealable container adapted to receive and store respiring horticultural produce, the container being substantially impermeable to oxygen and carbon dioxide;
a monitor for monitoring the oxygen or carbon dioxide content of the atmosphere in the container;
a delivery device for delivering a gas containing oxygen into an opposite side of the container to the monitor when the oxygen content approaches a level at which the produce would become anaerobic; and
a valve through which excess atmosphere from the container is expelled when the gas containing oxygen is delivered into the container;
whereby a high carbon dioxide content in the atmosphere in the container is maintainable such that the storage life of the produce may be extended.

21. An apparatus as claimed in claim 20, wherein the valve is in fluid communication with a tube, an entrance to the tube being situated close to the monitor.
